(19) United States
(12) Patent Application Publication
(10) Pub. No.: US 2010/0243454 A1
(43) Pub. Date: Sep. 30, 2010

(54) PROCESS FOR TREATING EXHAUST GAS GENERATED DURING WATER-GRANULATION OF SLAG AND SYSTEM FOR SAID TREATMENT

(75) Inventors: Tetsuo YAMAKI, Oita-shi (JP); Atsushi Kurosaka, Oita-shi (JP)

Correspondence Address: BIRCH STEWART KOLASCH & BIRCH, PO BOX 747, FALLS CHURCH, VA, 22040-0747, US

(73) Assignee: Pan Pacific Copper Co., Ltd., Tokyo (JP)

(21) Appl. No.: 12/728,861

(22) Filed: Mar. 22, 2010

Related U.S. Application Data
(63) Continuation-in-part of application No. 12/625,686, filed on Nov. 25, 2009.

(30) Foreign Application Priority Data
Mar. 26, 2009 (JP) 2009-77213
Oct. 30, 2009 (JP) 2009-250403
Jan. 19, 2010 (JP) 2010-009169

(51) Int. Cl. B03C 5/00; B01D 57/00

(52) U.S. Cl. 204/554; 204/660

(57) ABSTRACT

The present invention provides a process for treating a exhaust gas which is generated when slag discharged from a smelting furnace for non-ferrous metal is water-granulated. There is provided a process for treating an exhaust gas, which is generated during water granulation of slag discharged from a smelting furnace for non-ferrous metal, containing the water vapor as a major component and metal fumes, the process comprising a step of treating the exhaust gas by a wet electrostatic precipitator.

This application is a Continuation-In-Part of co-pending U.S. patent application Ser. No. 12/625,686, filed Nov. 25, 2009. This application also claims priority under 35 U.S.C. §119(a) to Japanese patent application No. 2009-077213, filed in Japan on Mar. 26, 2009, Japanese patent application No. 2009-250403, filed in Japan on Oct. 30, 2009, and Japanese patent application No. 2010-009169, filed in Japan on Jan. 19, 2010. The entire contents of all are herein incorporated by reference.

### BACKGROUND OF THE INVENTION

1. Field of the Invention

The present invention relates to a process for treating the exhaust gas generated during water granulation of slag discharged from a smelting furnace for non-ferrous metal. Particularly, it relates to a process for treating metal fumes contained in the exhaust gas. In addition, the present invention relates to a system for treating the exhaust gas which is generated when the slag discharged from a smelting furnace for non-ferrous metal is water-granulated. Particularly, it relates to the system for treating metal fumes contained in the exhaust gas.

2. Description of the Related Art

The smelting process of non-ferrous metals such as copper, lead, zinc and nickel forms matte, which is the mixture of impure metal sulfides, and slag, which is the dreg of non-metal composition, by the smelting reaction in the smelting furnace. The matte and slag are separated and discharged from the smelting furnace. For example, in the smelting process of copper, the concentrate of copper sulfide minerals is charged into the smelting furnace such as a blast furnace, a reverberatory furnace, a flash furnace and the like, and then heated and melted to form the matte containing high copper value and the slag mainly containing iron and silicic acid, subsequently, which are then separated and discharged. The matte is smelted by oxidizing blowing in a converter to produce crude copper. The slag is generally water-granulated using high-pressure brine or industrial water to the size which is easy to handle, and then subjected to landfill, or effectively used as construction materials and the like.

When the high-temperature slag discharged from the smelting furnace is water-granulated, exhaust gas containing a large amount of water vapor is generated. As a method for treating the exhaust gas generated during the water-granulation of slag, several methods are known for treating the exhaust gas generated when the slag discharged from the blast furnace for smelting iron is water-granulated.

For example, Japanese Patent Application Public Disclosure No. 8-245243 (Patent document 1) describes a method for removing H₂S gas and/or SO₂ gas, which is generated and mixed at the quenching reaction of the molten dreg with cold water, from a large amount of exhaust gas, which is generated when the molten dreg is water-granulated by adding cold water to the molten dreg discharged from a blast furnace.

The above method comprises reducing the temperature of the exhaust gas containing H₂S gas and SO₂ gas by scattering cooling water to the exhaust gas so that water vapor in the exhaust gas is condensed, and then saturating the exhaust gas by separating the condensed water, and then removing fine water droplets suspending in the exhaust gas to form a gas body of the saturated vapor, and then returning the gas body to the blast furnace so that H₂S gas and SO₂ gas may form slag by desulfurization reaction in the blast furnace (Claim 1). A wet electrostatic precipitator is mentioned as a means for removing the fine water droplets suspending in the exhaust gas to obtain a gas body of the saturated vapor.

In U.S. Pat. No. 5,540,895 (Patent document 2) describes a method for treating the vapor and gas containing H₂S and SO₂ generated during water-granulation of the slag from the blast furnace, the method comprising spraying alkaline water.

All of the methods described above are directed to the treatment of the exhaust gas generated at water-granulation of the slag produced at the process for smelting iron and no method for treating the exhaust gas generated at water-granulation of the slag discharged from the smelting furnace for non-ferrous metal is disclosed. To date, the exhaust gas generated during water granulation of slag discharged from a smelting furnace for non-ferrous metal has been usually released to the air without any treatment since it has not been thought that any component to be treated is contained in the exhaust gas. Thus, the components have not yet been analyzed in detail, and therefore, the components to be treated have not yet been revealed.

### SUMMARY OF THE INVENTION

Accordingly, one problem to be solved by the present invention is to provide a process for treating the exhaust gas generated during water granulation of slag discharged from a smelting furnace for non-ferrous metal. Further, another problem to be solved by the present invention is to provide a system for treating the exhaust gas generated during water granulation of slag discharged from a smelting furnace for non-ferrous metal.

The present inventor analyzed the exhaust gas generated during water granulation of slag discharged from a smelting furnace for non-ferrous metal and found that a trace amount of metal fumes such as iron and arsenic and the like were contained in a large amount of water vapor. The metal fumes, which are fine particles produced from condensation of metal vapor, should be prevented from being exhausted to the air from the viewpoint of preservation of the working environment and surrounding environment.

Metal fumes generally have a very small particle diameter, most of which are thought to be 1 μm or less. It is hard to collect the submicron particles in water droplets by inertia collisions. They are merely expected to be collected by Brownian diffusing motion. Accordingly, it is generally difficult to collect 90% or more of the particles by a spray tower with water droplets having a fine particle diameter. Further, the diameter of water droplets may not be maintained due to suspended substance (SS) contained in spray water and therefore, it is possible that the efficiency of collection may be reduced. In addition, scales may be deposited in the piping, and therefore, there is apprehension that the maintenance of the spray tower may be frequently required.

On the other hand, in the collection by a wet electrostatic precipitator (mist Cottrell precipitator), efficiency of dust collection of 80% or more may be attained even when the diameter of the dust particle is submicron. Therefore, the metal fumes may be removed by using a wet electrostatic precipitator. It has been known that the metal fumes may be collected by the wet electrostatic precipitator. However, as far as the present inventors' knowledge, there has not been the case where the wet electrostatic precipitator is applied to the treatment of the exhaust gas generated during water granulation of slag discharged from a smelting furnace for non-ferrous metal. Further, the necessity of such treatment also has not been recognized.

Accordingly, in one aspect, the present invention is a process for treating an exhaust gas, which is generated during water granulation of slag discharged from a smelting furnace for non-ferrous metal, containing the water vapor as a major component and metal fumes, the process comprising a step of treating the exhaust gas by a wet electrostatic precipitator.

In one embodiment of the process related to the present invention, the non-ferrous metal is copper.

In another embodiment of the process related to the present invention, the exhaust gas contains one or more of metal fumes selected from Cu, Zn, Ni and Fe.

In yet another embodiment of the process related to the present invention, the process further comprises a step of neutralizing and then filtrating waste water containing metal components discharged from the wet electrostatic precipitator to obtain a residue and returning the residue to the smelting furnace.

In another aspect, the present invention is a system for treating an exhaust gas, which is generated during water granulation of slag discharged from a smelting furnace for non-ferrous metal, containing the water vapor as a major component and metal fumes, the system comprising a means for collecting the exhaust gas, an exhaust gas duct and a wet electrostatic precipitator, wherein the means for collecting the exhaust gas is located above a spot where the exhaust gas is generated, and the means for collecting the exhaust gas and the wet electrostatic precipitator is connected via the exhaust gas duct.

In one embodiment of the system related to the present invention, the non-ferrous metal is copper.

In another embodiment of the system related to the present invention, the exhaust gas contains one or more of metal fumes selected from Cu, Zn, Ni and Fe.

The present invention makes it possible to remove the metal fumes from the exhaust gas which is generated when the slag discharged from the smelting furnace for non-ferrous metal is water-granulated.

### BRIEF DESCRIPTION OF THE DRAWINGS

FIG. 1 indicates one example of the scheme, related to the present invention, for treating the exhaust gas.

### DETAILED DESCRIPTION OF THE EMBODIMENT OF THE INVENTION

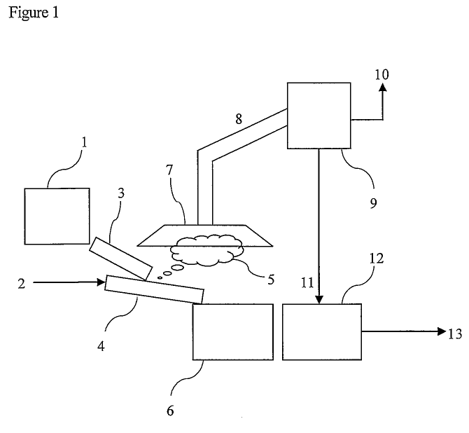

Preferred embodiments of the process for treating the exhaust gas related to the present invention is described below, referring to FIG. 1. Slag discharged from the smelting furnace 1 such as an electric slag cleaning furnace is flowed, through the slag runner 3, into the water-granulation runner 4 and then water-granulated by granulating water 2 flowed down through the water-granulation runner, and then fell into the water-granulation tank 6 as the water-granulated slag. The water-granulated slag is picked up by a bucket elevator (not indicated) provided in the water-granulation tank and carried away from the system.

The composition of the slag discharged from the smelting furnace differs depending on the kind of non-ferrous metal to be smelted. For example, in the process for smelting copper, it is in general, Fe: 35-45 mass %, Fe₃O₄: 3-15 mass %, SiO₂: 25-35 mass %, Cu: 0.5-3 mass %. Examples of non-ferrous metal, which is an object of the present invention, include, but not particularly limited to, copper, zinc and nickel.

The slag before water-granulation is usually at a high-temperature of about 1150-1300° C. From the vicinity of the water-granulation runner 4 and water-granulation tank 6 where the slag is contacted with water, a large amount of water vapor is generated as the exhaust gas 5. The generated water vapor, which contains a very small amount of the metal fumes is recovered by a hood for collecting smoke 7 (a means for collecting the exhaust gas) which covers over the water-granulation runner 4 and water-granulation tank 6, desirably the hood can move vertically and horizontally. The exhaust gas resulting from water-granulation contains metal fumes such as Cu, Zn and Fe generally at a concentration of about 0.1-10 mg/m³. However, the composition of metal fumes is different depending on the metal to be smelted. For example, in case where copper is smelted, the concentration of Zn is higher compared to other metals, which is usually about 1-10 mg/m³. The temperature of the exhaust gas in the hood for collecting the smoke is typically about 80-90° C.

Subsequently, the exhaust gas 5, recovered by the hood for collecting the smoke 7, including water vapor as a main component is introduced, through a flue 8 (the exhaust gas duct), into the wet electrostatic precipitator 9. The water vapor is partially condensed spontaneously as it passes through the flue 8. The temperature of the exhaust gas at the entrance of the wet electrostatic precipitator 9 is typically about 30-80° C. In the present invention, a means for scattering cooling water to the exhaust gas (cooling tower and the like) between the hood for collecting smoke and the wet electrostatic precipitator is not required.

The wet electrostatic precipitator 9 is a device which provides a high voltage between a discharging electrode and a dust collecting electrode to generate corona discharge, charging the particles suspending in the gas, and the particles being recovered by the dust collecting electrode by Coulomb force caused by electric field, and then discharges the recovered particles as waste water by washing them out with spray water. Metal fumes are fine particles, made by aggregation of metal vapor, which can be recovered by the wet electrostatic precipitator. However, it is desirable for obtaining a sufficient recovery to operate at a high voltage because most of them are a fine particle equal to or less than 1 μm.

The wet electrostatic precipitator is typically operated at a voltage of about 10-50 kV and a current of about 30-100 mA.

Any known wet electrostatic precipitator 9 may be used as appropriate. Examples of the wet electrostatic precipitator include a parallel type where a discharging electrode and a dust collecting electrode are arranged so that they are placed in parallel with gas flow, and a cross-flow type where a collecting electrode and a dust discharging electrode are arranged so that they are placed at a right angle to the gas flow (Ex. Neueluft type).

The exhaust gas 10 discharged from the wet electrostatic precipitator 9 can be released into the air. The temperature of the exhaust gas at the exit of the wet electrostatic precipitator 9 is about 20-40° C. On the other hand, the waste water 11 containing the recovered metal discharged from the wet electrostatic precipitator 9 is recovered by the waste water tank 12, and then pumped out to a combined waste water treatment facility where the waste water is subjected to neutralizing treatment and then filtrated with a filter press. The metal recovered as a residue can be returned to the smelting furnace as mixed minerals.

### EXAMPLES

Working example for the present invention will be explained below, which is only for illustrative purpose and it is not intended for restricting the present invention.

### Example 1

In this working example, the treatment of the exhaust gas which was generated during water-granulation of high-temperature slag discharged from an electric slag cleaning furnace attached to a flash furnace was performed. A system for treating the exhaust gas was constructed according to the scheme for treating the exhaust gas depicted in FIG. 1. The slag discharged from the electric slag cleaning furnace flows, through the slag runner, into the water-granulation runner, and then water-granulated by granulating water flowed down through the water-granulation runner, and then fell into the water-granulation tank as water-granulated slag. The exhaust gas containing a large amount of water vapor resulting from water-granulation was recovered by a hood for collecting smoke that covers over the water-granulation runner and water-granulation tank. The temperature of the exhaust gas in the hood for collecting the smoke is about 80-90° C. The exhaust gas recovered by the hood for collecting the smoke enters the flue, through the entrance of the flue which is placed at the top of the hood and travels to the wet electrostatic precipitator. The temperature of the exhaust gas flowed into the wet electrostatic precipitator was about 30-80° C. The temperature of the exhaust gas discharged from the wet electrostatic precipitator was about 20-40° C.

The conditions for the water-granulation of the slag were as follows:

| | | |
|---|---|---|
| The amount of slag to be water-granulated | 2.5 | t/min |
| The temperature of slag before water-granulation | 1150-1300° | C. |
| The amount of water for water-granulation | 20 | t/min |

The result of the concentration of the metals (mass %) in the slag measured by methods for determination of metals in flue gas according to JIS K0083 is shown in Table 1.

TABLE 1

| | Element | | |
|---|---|---|---|
| | Cu | Zn | Fe |
| Conc. (%) | 0.83 | 0.76 | 39.2 |

The operation conditions of the system for treating the exhaust gas were as follows.

The amount of the exhaust gas recovered by the hood for collecting the smoke 300 m³/min
The specification of the wet electrostatic precipitator
   maker: Erdec company Neueluft type
   voltage: 15-25 kV
   current: 60-100 mA
   amount of spray water: about 20 L/min

The concentration of metals in the exhaust gas recovered by the hood for collecting the smoke (the concentration at the entrance of the precipitator), the concentration of metals in the exhaust gas after the treatment by the wet electrostatic precipitator (the concentration at the exit of the precipitator), and the recovery rate (%) are shown in Table 2. The measurement of the concentration of the metals was carried out by methods for determination of metals in flue gas according to JIS K0083.

TABLE 2
(mg/m³)

| | Element | | |
|---|---|---|---|
| | Cu | Zn | Fe |
| The concentration at the entrance | 0.18 | 5.33 | 0.67 |
| of the precipitator | | | |
| The concentration at the exit | 0.03 | 0.21 | 0.04 |
| of the precipitator | | | |
| The recovery rate (%) | 80.7 | 96.0 | 94.1 |

### Example 2

As in Example 1, the treatment of the exhaust gas which was generated during water-granulation of high-temperature slag discharged from an electric slag cleaning furnace attached to a flash furnace was performed. However, in Example 2, the amount of exhaust gas recovered at the hood for collecting smoke was larger than in Example 1.

The conditions for the water-granulation of the slag were as follows:

| | | |
|---|---|---|
| The amount of slag to be water-granulated | 2.5 | t/min |
| The temperature of slag before water-granulation | 1150-1300° | C. |
| The amount of water for water-granulation | 20 | t/min |

The operation conditions of the system for treating the exhaust gas were as follows.
The amount of the exhaust gas recovered by the hood for collecting the smoke 500 m³/min
The specification of the wet electrostatic precipitator
   maker: Erdec company Neueluft type (two chambers, three stages type)
      Chamber indicates the number of chambers as electric charge is given by one high voltage power supply per each chamber.
      Stage indicates the number of stages aligned in the direction of gas flow as a pair of a discharging electrode and a dust collecting electrode constitutes one stage.
   voltage: 30-35 kV (for the first and second chambers)
   current: 110-150 mA (for the first chamber), 140-180 mA (for the second chamber)
   amount of spray water: about 10 L/min

Temperature, flow rate, weight of recovered metal fumes, concentration of metal fumes and collection efficiency (%) at the inlet and outlet of the precipitator are shown in Table 3. The concentration and recovery rate (%) of Cu, Zn and Fe fumes among the metal fumes at the inlet and outlet of the precipitator are shown in Table 4. It was shown that the metal fumes in the exhaust gas were collected with a high efficiency. The measurement of the concentration of metal fumes and metals was carried out by methods for determination of metals in flue gas according to JIS K0083.

TABLE 3

| | | | Gas | Weight of | | | EP charge conditions | | | |
|---|---|---|---|---|---|---|---|---|---|---|
| | | | flow rate | recovered | Conc. of | | First | | Second | |
| | | Gas | (standard conditions) | metal | metal fumes | collection | chamber | | chamber | |
| | | temp. | [Nm3/min] | fumes | [mg/Nm3] | efficiency | voltage | current | voltage | current |
| | | [° C.] | (wet) | [mg] | (dry) | [%] | [kV] | [mA] | [kV] | [mA] |
| No. 1 | Inlet | 73 | 496 | 9.6 | 7.92 | 96.89 | 33 | 140 | 31 | 160 |
| | Outlet | 41 | 489 | 0.3 | 0.25 | | | | | |
| No. 2 | Inlet | 81 | 531 | 13.8 | 10.68 | 96.93 | 34 | 120 | 31 | 160 |
| | outlet | 40 | 500 | 0.4 | 0.33 | | | | | |

TABLE 4

| | | Cu | | Zn | | Fe | |
|---|---|---|---|---|---|---|---|
| | | Conc. | Recovery | Conc. | Recovery | Conc. | Recovery |
| | | [mg/Nm3] | rate | [mg/Nm3] | rate | [mg/Nm3] | rate |
| | | (dry) | [%] | (dry) | [%] | (dry) | [%] |
| No. 1 | Inlet | 0.685 | 91.61 | 0.280 | 97.66 | 0.404 | 100.00 |
| | Outlet | 0.057 | | 0.007 | | 0.000 | |
| No. 2 | Inlet | 0.542 | 89.41 | 0.224 | 98.17 | 0.302 | 100.00 |
| | outlet | 0.057 | | 0.004 | | 0.000 | |

| | | | | | |
|---|---|---|---|---|---|
| Average | — | 90.5 | — | 97.9 | 100.0 |

What is claimed is:

1. A process for treating an exhaust gas, which is generated during water granulation of slag discharged from a smelting furnace for non-ferrous metal, containing the water vapor as a major component and metal fumes, the process comprising a step of treating the exhaust gas by a wet electrostatic precipitator.

2. The process according to claim 1, wherein the non-ferrous metal is copper.

3. The process according to claim 1, wherein the exhaust gas contains one or more of metal fumes selected from Cu, Zn, Ni and Fe.

4. The process according to claim 1, further comprising a step of neutralizing and then filtrating waste water containing metal components discharged from the wet electrostatic precipitator to obtain a residue and returning the residue to the smelting furnace.

5. A system for treating an exhaust gas, which is generated during water granulation of slag discharged from a smelting furnace for non-ferrous metal, containing the water vapor as a major component and metal fumes, the system comprising a means for collecting the exhaust gas, an exhaust gas duct and a wet electrostatic precipitator, wherein the means for collecting the exhaust gas is located above a spot where the exhaust gas is generated, and the means for collecting the exhaust gas and the wet electrostatic precipitator is connected via the exhaust gas duct.

6. The system according to claim 5, wherein the non-ferrous metal is copper.

7. The system according to claim 5, wherein the exhaust gas contains one or more of metal fumes selected from Cu, Zn, Ni and Fe.
